(19) United States
(12) Patent Application Publication
(10) Pub. No.: US 2005/0158875 A1
(43) Pub. Date: Jul. 21, 2005

(54) Liquid transfer positioning

(76) Inventors: Patrick Kaltenbach, Bischweier (DE); Konstantin Choikhet, Karlsruhe (DE); Gerhard Ple, Karlsruhe (DE); Clemens Linowski, Waldbronn (DE)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 11/036,616

(22) Filed: Jan. 18, 2005

(30) Foreign Application Priority Data
Jan. 15, 2004 (EP) 04000688.4

(51) Int. Cl. B01L 3/00

(52) U.S. Cl. 436/180

(57) ABSTRACT

A liquid transfer appliance and a well plate are moved towards each other and a current is detected that flows upon contact between the liquid transfer appliance and a first electrically conductive element of the well plate. The position of the well plate relative to the liquid transfer appliance is determined at the time of contact. The determined position is used as a reference position for further positioning at least one of the well plate and the liquid transfer appliance.

### RELATED APPLICATIONS

The present application is based on, and claims priority from, EP Application Serial Number 04000688.4, filed Jan. 15, 2004, the disclosure of which is hereby incorporated by reference herein in its entirety.

### BACKGROUND OF THE INVENTION

In analytical chemistry, especially in bioanalytical chemistry, a limited sample amount is often available for further processing, for example for further analysis. The samples are typically stored and handled in well plates, comprising one or more wells on a plate. Due to the limited sample amount, often just a few 10 μl or less, the liquid levels of the samples in the wells are usually very low.

U.S. Pat. No. 5,855,851 discloses an apparatus for detection of a level of a liquid in a container using detection of electrostatic capacitance between the container holder and an electrode.

### SUMMARY OF THE INVENTION

It is an object of the present invention to provide a new and improved positioning method and apparatus for transfer of liquids between at least one well and a transfer appliance.

In the context of this document a transfer appliance includes but is not limited to all kinds of devices used to transfer liquids between different locations, e.g., sippers or pipettes, which can also be connected to intake equipment, e.g., syringes or pumps. Transfer refers to the transfer of liquid from the well plate into the transfer appliance as well the transfer of liquid from the transfer appliance into the well plate. Liquids and fluids are considered to be synonymous terms, the term “liquid” being used in this document for both terms.

Because of the low sample liquid levels and the small amount of liquid sample transferred, it is desirable to improve the positioning of a transfer appliance relative to the at least one well of a well plate.

In accordance with one aspect of the invention, a method of positioning at least one of a well plate and a liquid transfer appliance for transferring a first liquid between at least one well of a well plate and the liquid transfer appliance comprises moving A) the liquid transfer appliance and the well plate towards each other and detecting a current caused upon contact between the liquid transfer appliance and a first electrically conductive element of the well plate, B) determining the position of the well plate relative to the liquid transfer appliance at the point of time of contact, and C) using the position determined in step B) as a reference position for further positioning at least one of the well plate and the liquid transfer appliance.

Preferably, the further positioning in step C) includes positioning the at least one transfer appliance in the at least one well.

Preferably, electric potentials are applied to different elements that are electrically isolated from each other prior to step A). An electrical connection between the said elements is established in step A).

An electric field is preferably applied between at least two second electrically conductive elements of different transfer appliances or between at least one second element of a transfer appliance and the first element.

Preferably, the first element comprises a foil covering the at least one well and the second element comprises an electrically conductive material of the transfer appliance or a second liquid present in the transfer appliance.

Step B) preferably includes calculating an observed one-dimensional relative positioning value by using the following experimental data: (1) time of occurrence of the current and (2) velocity of the relative movement of the well plate against the transfer appliance; and step C) includes determining a one-dimensional offset positioning error by comparing the observed positioning value with a theoretical positioning value.

Step B) preferably includes determining a one-dimensional offset positioning error by registering the position of a positioner for bringing the well plate in contact with the at least one transfer appliance. The offset positioning error is determined at the time of the contact between the transfer appliance and the first element.

Preferably, at least steps A) to B) are repeatedly carried out such that the at least one transfer appliance is brought into contact with the first element of the well at different points of contact so step B) determines a one-dimensional offset positioning error for each contact point.

At least one of the features is preferably performed so: (1) at least three different one-dimensional positioning offset errors are used to calculate the position of the whole well plate relative to the transfer appliance, and (2) at least two different one-dimensional positioning offset errors are used to calculate the offset and the tilt error of the well plate relative to the transfer appliance.

The method is completed by D) transferring the first liquid between the at least one of the well plate and the liquid transfer appliance. Step D) preferably includes transferring the first liquid from the well to the transfer appliance, and vice versa. Preferably, the transfer appliance is immersed in the first liquid in the well during step D).

Advantageously in step D) the immersion depth of the at least one transfer appliance in the well is such that the transfer appliance does not contact the bottom of the well. The information about the positioning error obtained in step B) can be used to accurately immerse the transfer appliance in a liquid present in the well, e.g., the first liquid.

Preferably the at least one transfer appliance is driven to pierce through the electrically conductive foil as the first element in step C) or D) of the method. This means, that the electrically conductive foil is not removed before further positioning or immersing of the transfer appliance in the liquid in the well.

Advantageously the first liquid in the well is transferred to a microfluidic device in method step D). Microfluidic devices normally comprise a substrate made, e.g., of glass or silicon having conduits formed therein. These conduits can be filled with a gel matrix for the analysis of samples. Normally reservoirs are formed at the endpoints of the conduits in the substrate of the microfluidic device. The conduit can be filled with an aqueous solution in which electrodes are immersed. These electrodes apply an electric field across the conduits in order to electrokinetically transport the samples through the conduits using gel electrophoresis. Electrophoretic separation is often used in high throughput automated instruments, for example in the so called ALP-instruments (automated lap on a chip platform) including the above mentioned microfluidic devices. In these ALP-instruments, tolerances in the positioning of the well plate in the well plate handler can occur; for example, a gripper can cause misalignment of the transfer appliances relative to the wells leading to positioning errors. Tolerances leading to positioning error might also occur when the microfluidic device is positioned relative to the transfer appliance.

The above mentioned embodiment of the method of the invention has the advantage, that the first liquid transferred can be further analyzed and processed in a fast and reliable way in a microfluidic device for, example, using gel electrophoresis in a method step E). The above mentioned ALP-instruments are well suited for further processing of the first liquid.

When the first liquid is transferred from the wells to a microfluidic device, the first liquid is preferably transferred in step D) into the system of conduits formed in the microfluidic device. The conduits are in flow communication with containers containing a second liquid and the electrodes are immersed in the second liquid. The containers are preferably located on the above mentioned reservoirs, which are located at the endpoints of the conduits of the microfluidic device. In this case the electrodes in the containers immersed in the second liquid can fulfill different purposes. The electrodes can be used to apply an electric field to the second liquid, so that the method can be carried out. A current is generated in response to the second liquid in the transfer appliances (second element) being in contact with the electrically conductive foil (first element). The electrodes can also be used to apply an electric field across the conduits formed in the microfluidic device, so that the first liquid transferred to the conduits of the microfluidic device can further be electrokinetically driven through the conduits for further processing.

The second liquid preferably comprises an aqueous solution, which can also be used to form the gel matrix that fills the conduits of the microfluidic device. In this embodiment of the invention the gel matrix is contained within the conduits of the microfluidic device and is the second liquid used in the method, or is connected to the liquid.

Step D) also preferably includes transferring first liquids in different wells of the well plate to different transfer appliances. Transfer appliances for performing the transfer operation are in flow communication with containers including a second liquid and electrodes immersed in the second liquid. The containers are preferably connected to conduits of a microfluidic device, wherein the conduits are filled with a gel matrix or buffer or standard solution.

The method can be performed such that the first liquid comprises a solution including analyte molecules preferably selected from a group including: nucleic acids, peptides, carbohydrates, ionic organic substances, ionic inorganic substances and soluble substances, which can be electro-kinetically transported within the conduits, e.g., using micellar electophoresis.

Preferably, step A) includes positioning the well plate on or in a movable plate holder and the well plate is transported towards the transfer appliance by moving the plate holder.

Another aspect of the invention relates to an apparatus for positioning at least one of a well plate and a liquid transfer appliance adapted for transferring a first liquid between at least one well of the well plate and the liquid transfer appliance. The apparatus comprises: (1) a positioner for moving the liquid transfer appliance and the well plate towards each other, (2) a detector for detecting a current caused by contact between the liquid transfer appliance and a first electrically conductive element of the well plate, and (3) a processing unit for determining the position of the well plate relative to the liquid transfer appliance at the point of time of contact, and for using the determined position as a reference position for further positioning of at least one of the well plate and the liquid transfer appliance. Such a detector includes, e.g., an ammeter or a voltmeter. The processing unit is arranged for determining and calculating the position of the well plate relative to the transfer appliance. This processing unit can be part of a microcomputer connected to the apparatus or be part of an internal or external controller.

The method preferably uses a current generated in response to contact between a first electrically conductive element of the well plate and at least one transfer appliance at a contact point in step A) in order to determine the relative position of the transfer appliance and the well plate at the time of contact. The generated current indicates the transfer appliance has contacted the first element of the well plate and can be used to determine (1) the actual position of the well plate relative to the at least one transfer appliance at the point of contact and (2) a positioning error at this point of contact in method step B). In step C) of the method, the information obtained in step B) about the positioning error can be used for further positioning of the well plate and the transfer appliance.

This further positioning can, e.g., include positioning of the transfer appliance in the well. Due to the improved positioning of the transfer appliance, blockage of the transfer appliance by contacting the well bottom or the transfer of air due to insufficient transfer appliance immersion depth in the well can be reduced in comparison with conventional methods.

The method reduces positioning errors of the transfer appliance relative to the well plate. These positioning errors might be due to tolerances in the mechanics of the instrument, for example tolerances of the drive of the well plate handler responsible for transporting the well plate to the transfer position and/or tolerances in the positioning of the well plate on the well handler or the like.

The first electrically conductive element of the well plate can comprise different elements, which can be part of the well plate, e.g., an electrically conductive contact point protruding from the at least one well for contact with the transfer appliance. The first element can also comprise an element, which is in contact with the well plate, e.g., an electrically conductive foil covering the well plate. Such a foil, e.g., an aluminum foil, can prevent the evaporation of the samples out of the wells of the well plate and can be fixed to the well plate by; e.g., using a sealing apparatus, which can adhere the foil to the well plate.

The current resulting from contact between the transfer appliance and the first electrically conductive element can be generated using different procedures. For example an electric field can be applied between second electrically conductive elements of different transfer appliances in the case of more than one transfer appliance being present. The second elements can be pipette tubes made of an electrically conductive material, e.g., metal, or it might comprise elements which are in contact with the transfer appliance, e.g., a second liquid in the transfer appliance. These second elements are spaced at the beginning of the operations and are therefore initially electrically isolated from each other. Upon contact of the first and second elements, the first element .establishes an electrical connection between at least two second elements, so that a current flows and is detected in step A). Using this embodiment, an electrically conductive foil covering the well plate is preferably used as the first element.

It is also possible to apply an electrical potential to a second element of the transfer appliance and a different electrical potential to the first element, e.g., an electrically conductive foil. Using this embodiment of the method, the current flows upon contact of the second element of the transfer appliance with the first element, so that, e.g., a direct electrical connection between the first and second element is established. An external electrical connection to the foil can be created, so that the foil can, e.g., be grounded.

In a further embodiment, an observed one dimensional relative positioning value is calculated using experimental data, such as time of occurrence of the current and velocity of the relative movement of the well plate against the transfer appliance.

This one dimensional relative positioning value is then compared in step B) with a theoretical positioning value, to thereby determine the actual one dimensional offset positioning error. The theoretical positioning value might, for example, be stored in a control system, for example, a microcomputer or an internal instrument controller, which can be connected to the transfer appliance. Using this embodiment for a series of contact points between the electrically conductive foil and the transfer appliance, a matrix of offset positioning errors for the whole well plate can be calculated.

As an alternative to the latter mentioned embodiment, the position of the well plate is directly registered. In step B) the position of a positioner for bringing the well plate in contact with the at least one transfer appliance is registered at the time of the contact between the transfer appliance and the first element, thereby determining a one dimensional offset positioning error at this point of contact. The positioner might, e.g., comprise a well plate holder with a drive for moving the well plate towards the transfer appliance or might comprise a drive connected to the transfer appliances for moving the transfer appliances towards the well plate.

In a further embodiment of the method of the invention at least steps A) to B) are repeatedly carried out. The at least one transfer appliance is brought into contact with the electrically conductive foil at different points of contact in step B). As for each point of contact, a one-dimensional offset positioning error is determined. In this case all points provide information for building the offset error matrix for the whole plate.

This further embodiment enables at least three different one-dimensional positioning errors to be used to calculate the position of the whole well plate relative to the transfer appliance in three-dimensional space. Therefore, three one-dimensional pieces of information about the location of the well plate relative to the transfer appliances are used to calculate the three-dimensional position of the whole well plate. This embodiment also enables further transfer steps to be carried out without the need to additionally determining the position of the well plate. Therefore the transfer steps carried out after the complete position of the well plate has been determined can be carried out faster because no determination of the one-dimensional positioning error must be performed. It is also possible to use more than three values of the one-dimensional positioning error at different points to determine the three-dimensional position of the well plate relative to the transfer appliances. In this case, the extra information obtained from the fourth, fifth etc. one-dimensional positioning errors can be used to eliminate errors and enhance the accuracy of the calculated three-dimensional position of the well plate.

It is also possible to use only two one-dimensional offset positioning errors in order to calculate only the offset and the tilt of the well plate. Such an embodiment might be sufficient, e.g., when the positioning errors are relatively small.

The method of the invention can be carried out using conventional transfer appliances. For example it is possible to use conventional transfer appliances comprising metal pipes. In order to carry out the method using such transfer appliances, electrical connections to the metal pipes can apply an electrical potential to the pipes (second element). On the other hand it is also possible to use the conventional ALP-instruments and simply use the electrodes already present in such instruments to apply an electric field to the second liquid within the transfer appliances.

In the following the invention will be explained in more detail by the Figures and embodiments. All Figures are just simplified schematic representations presented for illustration purposes only.

### BRIEF DESCRIPTION OF THE DRAWINGS

FIG. 1 is a cross sectional schematic of a microfluidic device and its surrounding area in an ALP-instrument during step A) of the method of the invention.

FIGS. 2 and 3 are perspective views of an ALP-instrument above a well plate.

FIGS. 4A and 4B are diagrams showing how the current is generated during the positioning method when the transfer appliances are in contact with the electrically conductive foil.

### DETAILED DESCRIPTION OF THE DRAWING

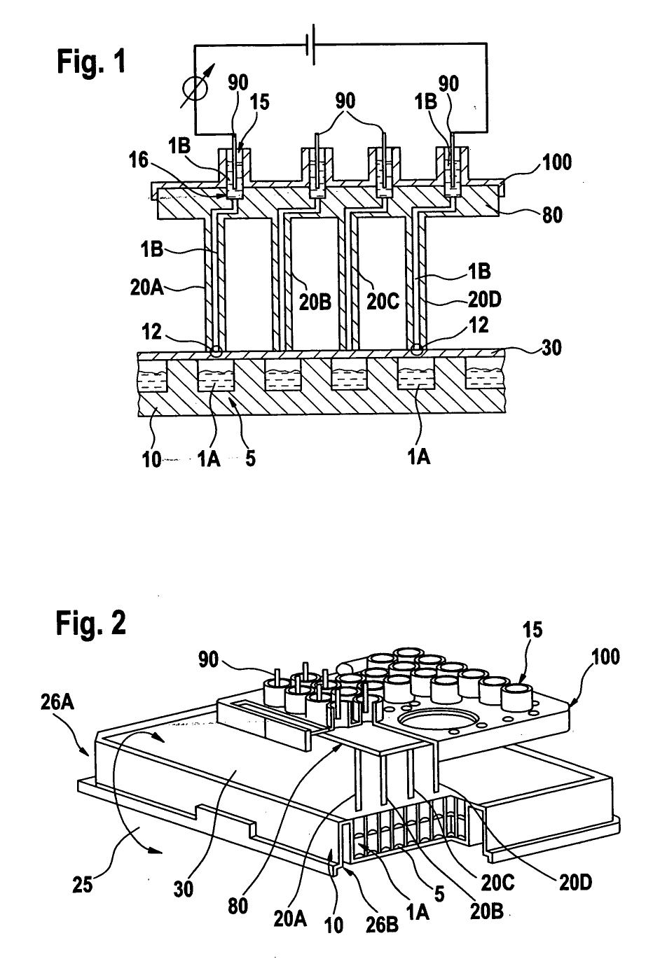

Referring to FIG. 1 an automated lab on a chip platform is shown in cross sectional view. The microfluidic device comprises a top part 100 made of a polymer or plastic which is mounted on top of a microfluidic chip 80. The top part 100 also comprises containers 15 which are located above the reservoirs 16 of the microfluidic chip 80. The reservoirs 16 are normally located at the end points of the micro channel system of conduits which are formed within the microfluidic chip 80. In this variant of the ALP-instrument, the microfluidic chip 80 also comprises four transfer appliances 20A, 20B, 20C and 20D. It is also possible to use microfluidic chips having just one, two, three or even more than four transfer appliances. Each container 15, that is connected to a system of conduits and its corresponding reservoir 16 is in flow communication with one transfer appliance via capillaries. Each transfer appliance 20A to 20D also holds a second liquid 1B inside the capillaries, the second liquid 1B is also located in the reservoirs 16 and the containers 15 or is in flow connection to another liquid in the reservoirs and/or containers. Each transfer appliance can be connected to a plurality of wells, e.g., at least 6 wells. Electrodes 90 are immersed in each second liquid for application of an electric potential. All but one of the electrodes are connected to each transfer appliance and are normally set to a “zero current mode” during step C). The remaining electrode is connected to each transfer appliance and is set in a “constant voltage” mode, so that a defined potential is applied to each transfer appliance. To simplify the disclosure, an electrical field is shown as being applied to only the two electrodes 90 of the transfer appliances 20A and 20D in FIG. 1.

At the end of step A) the transfer appliances 20A to 20D are in contact with the electrically conductive foil 30, for example an aluminum alloy foil, which covers the well plate 10. Upon contact of the transfer appliances 20A and 20D, the second liquid 1B, to which an electric potential is applied, contacts the electrically conductive foil 30 at the contact points 12. A current is generated upon contact of the transfer appliances 20A and 20D to the electrically conductive foil 30. The current is detected and used to determine the positioning error of the well plate 10 relative to the transfer appliances. Afterwards in step C) or D), the transfer appliances 20A to 20D preferably pierce through the electrically conductive foil 30 and are immersed in the first liquids 1A located in the wells 5 of the well plate 10, using information about the positioning error. Thereby, the first liquids 1A are transferred into the transfer appliances 20A to 20D.

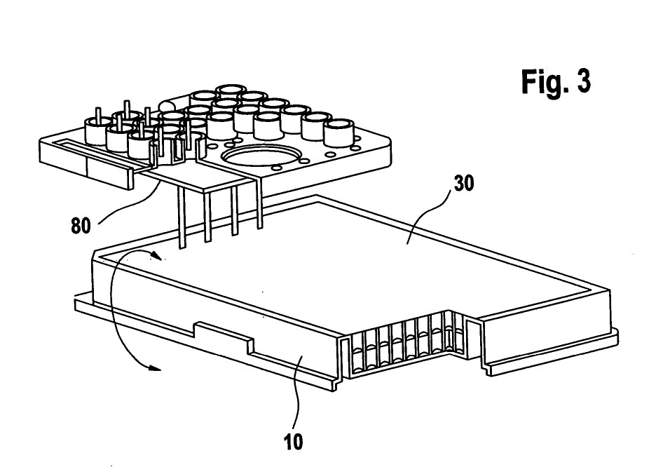

Turning now to FIG. 2, a perspective view of an ALP-instrument located above a well plate 10 is shown during step A). The four transfer appliances 20A to 20D of the microfluidic chip 80 and the well plate 10 are moved towards each other until the transfer appliances are in contact with the electrically conductive foil 30 covering the well plate 10. In FIG. 2 are also shown a plurality of reservoirs or containers 15. Normally an electrode 90 is immersed in each reservoir 15, but in this case just a few electrodes 90 are shown in order to simplify the Figure. Due to differences in the tilt angle of the well plate in the gripper of a well plate holder, a misalignment or tilt 25 can be caused. As a result, two opposing edges 26A and 26B of the well plate 10 are on different levels.

In FIG. 3, the well plate 10 of FIG. 2 is moved to a different position relative to the microfluidic device, resulting in a different contact point between the transfer appliances and the electrically conductive foil 30 compared to FIG. 2. Carrying out the positioning method and different contact points results in an array different one-dimensional offset positioning errors being determined for each point of contact. These different one-dimensional offset positioning errors can be combined to calculate a more precise three-dimensional position of the entire well plate relative to the transfer appliances. After having calculated the position of the well plate relative to the transfer appliances, an additional series of transfer steps can be performed without the need to further detect the positioning error. This is because the already obtained information can be used to correct the immersion depth of the transfer appliances in the first liquids for each new contact point during this subsequent series of transfer steps.

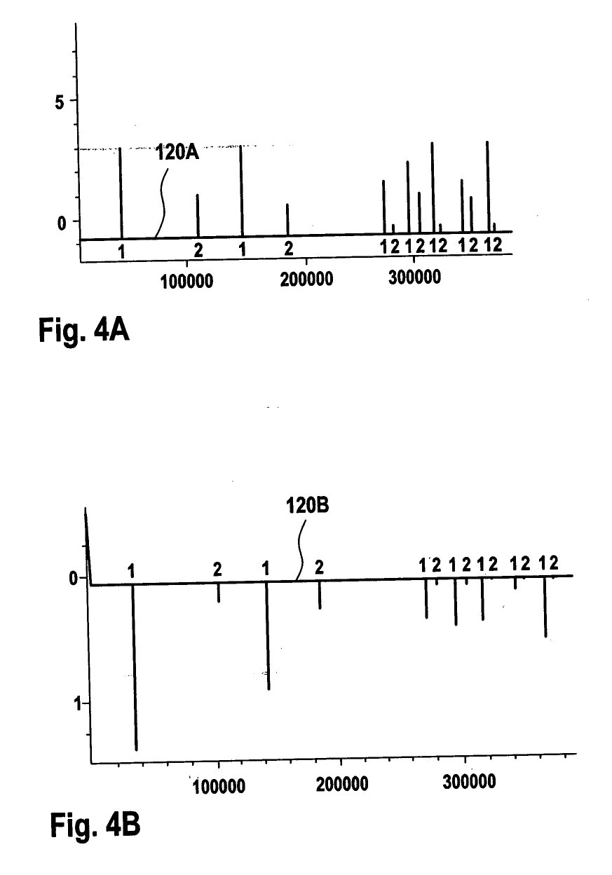

The diagrams of FIGS. 4A and 4B show a current being generated when the second liquid in the transfer appliance contacts the electrically conductive foil. The Y-axis indicates current in μA and the X-axis indicates timescale in milliseconds. The graphs 120A and 120B in the FIGS. 4A and 4B show the current jumps for two different transfer appliances when they are brought into contact with the foil at different contact points, for example, as shown in FIGS. 2 and 3. The peaks 1 indicate the current jump that occurs in response to the second liquid in the transfer appliance contacting the electrically conductive foil when the well plate is moved towards the foil at the beginning of step B). The peaks 2 indicate a current which is generated in response to the transfer appliances being transported out of the first liquid again and a small drop of liquid located at the tip of the transfer appliance (subjected to an electrical potential) being in contact with the electrically conductive foil again. The current in FIG. 4A resulted from the application of a voltage of 1600 V to the transfer appliance, whereas the current in FIG. 4B resulted from a voltage of 200 V being applied to the appliance. Both diagrams show, that the transfer appliances were moved to seven different points of contact with the electrically conductive foil, brought in contact with the foil (peak 1) immersed in the first liquid in the wells and transported out of the liquid again (peak 2) at each point of contact.

The scope of the invention is not limited to the embodiments shown in the Figures. Indeed variations, especially concerning the number of transfer appliances are possible.

1. A method of positioning at least one of a well plate and a liquid transfer appliance for transferring a first liquid between at least one well of a well plate and the liquid transfer appliance, the method comprising the steps of:
A) moving the liquid transfer appliance and the well plate towards each other and detecting a current that flows in response to contact between the liquid transfer appliance and a first electrically conductive element of the well plate,
B) determining the position of the well plate relative to the liquid transfer appliance at the point of time of contact, and
C) using the position determined in step B) as a reference position for further positioning at least one of the well plate and the liquid transfer appliance.

2. The method of claim 1, wherein
in step C) the further positioning includes positioning the at least one transfer appliance in the at least one well.

3. The method of claim 1, further including:
applying electric potentials to different elements that are electrically isolated from each other prior to step A), and
step A) includes establishing an electrical connection between the elements.

4. The method according to claim 3, wherein
an electric field is applied between at least two second electrically conductive elements of different transfer appliances or between at least one second element of a transfer appliance and the first element.

5. The method according to claim 1, wherein
the first element comprises a foil covering the at least one well.

6. The method of claim 4, wherein
the second element comprises an electrically conductive material of the transfer appliance.

7. The method of claim 4, wherein
the second element comprises a second liquid present in the transfer appliance.

8. Method according to claim 1, wherein
step B) includes calculating an observed one-dimensional relative positioning value by using the following experimental data: occurrence time of the current and velocity of the relative movement of the well plate versus the transfer appliance,
step C) includes determining a one-dimensional offset positioning error by comparing the observed positioning value with a theoretical positioning value.

9. Method according to claim 1, wherein
step B) includes determining a one-dimensional offset positioning error by determining the position of a positioner for bringing the well into contact with the at least one transfer appliance, the determined position being at the time of the contact between the transfer appliance and the first element.

10. Method according to claim 1, further including repeatedly performing at least the steps A) and B), in step B) determining a one-dimensional offset positioning error for each point of contact by bringing the at least one transfer appliance into contact with the first element of the well at different points of contact.

11. Method according to claim 9, comprising at least one of the features: calculating the position of the whole well plate relative to the transfer appliance by using at least two different one-dimensional positioning offset errors, calculating the offset and the tilt error of the well plate relative to the transfer appliance by using at least two different one-dimensional positioning offset errors.

12. The method of claim 1, further comprising the step of:
A) transferring the first liquid between the at least one of a well plate and the liquid transfer appliance.

13. The method of claim 12, wherein
step D) includes transferring the first liquid from the well to the transfer appliance while the transfer appliance is immersed in the first liquid present in the well.

14. Method according to claim 13, comprising at least one of: (a) in step D) immersing the transfer appliance into the well to a depth such that the transfer appliance does not contact the bottom of the well; (b) the second element includes a foil covering the well plate and step D) includes piercing the foil by driving the transfer appliance through the foil so the transfer appliance is immersed in the first liquid; c) step D) includes transferring the first liquid to a microfluidic device.

15. Method according to claim 1,
wherein step D) includes transferring first liquids in different wells of the well plate to different transfer appliances, wherein the transfer appliances are in flow communication with containers including a second liquid and electrodes immersed in the second liquid.

16. Method according to claim 15,
wherein the containers are connected to microfluidic device conduits filled with a gel matrix or buffer or standard solution.

17. Method according to claim 1, further including analyzing the first solution in a microfluidic device.

18. Method according to claim 1,
wherein the first liquid comprises a solution including analyte molecules, selected from a group including:
nucleic acids, peptides, carbohydrates, ionic organic substances, ionic inorganic substances and soluble substances, which can be electro-kinetically transported within the conduits.

19. Method according to claim 1, wherein step A) includes positioning the well plate on or in a movable plate holder and transporting the well plate towards the transfer appliance by moving the plate holder.

20. An apparatus for positioning at least one of a well plate and a liquid transfer appliance adapted for transferring a first liquid between at least one well of the well plate and the liquid transfer appliance, comprising:
a positioner for moving the liquid transfer appliance and the well plate towards each other,
a detector for detecting a current caused to flow in response to contact between the liquid transfer appliance and a first electrically conductive element of the well plate, and
a processing unit for determining the position of the well plate relative to the liquid transfer appliance at the time of contact, and for using the determined position as a reference position for enabling further positioning of at least one of the well plate and the liquid transfer appliance.
